(19) United States
(12) Patent Application Publication
(10) Pub. No.: US 2019/0333230 A1
(43) Pub. Date: Oct. 31, 2019

(54) METHOD FOR CONTROLLING A MACHINE BY MEANS OF AT LEAST ONE SPATIAL COORDINATE AS CONTROL VARIABLE AND CONTROL SYSTEM OF A MACHINE

(71) Applicant: Oliver Horst Rode, Frankfurt am Main (DE)

(72) Inventor: Oliver Horst Rode, Frankfurt am Main (DE)

(21) Appl. No.: 16/394,735

(22) Filed: Apr. 25, 2019

(30) Foreign Application Priority Data
Apr. 30, 2018 (DE) 102018206675.2

(51) Int. Cl. G06T 7/246; G06T 7/80; G06T 7/73; G06T 7/90; G05B 19/402

(52) U.S. Cl. CPC G06T 7/246; G06T 7/80; G06T 7/73; G05B 2219/40538; G05B 19/402; G06T 2207/30204; G06T 2207/10024; G06T 7/90

(57) ABSTRACT

A machine is controlled using at least one spatial coordinate as a control. Controlling a machine using at least one spatial coordinate as a control variable may include determining a vectorial space coordinate by means of a two-dimensional code applied to a carrier plane and readable by means of an optical image processing system, and transmitting the vectorial space coordinate as a control variable to a control system of the machine. The spatial position of a normal vector perpendicular to the area center of gravity of the code may be determined by an image processing system, and an the angle of rotation of a rotational movement of the carrier plane of the code about an axis of rotation perpendicular to the carrier plane may be detected by the image processing system, the length of the normal vector being determined from the angle of rotation.

### TECHNICAL FIELD

The system described herein concerns a method for controlling a machine by means of at least one spatial coordinate as a control variable. The system described herein also concerns a control system for a machine.

### BACKGROUND OF THE INVENTION

The control of machines by means of space coordinates may be known from the state of the art. However, the space coordinates must always be specified in an absolute or relative reference system, so that both the controlled machine and the controlling instance have a synchronized and identical understanding of their meaning content when implementing control commands based on these space coordinates. Usually, therefore, the space coordinates are specified in an absolute coordinate system, which is stored both in the control system of the controlled machine and in the controlling instance. In this way, a control command can be transmitted, for example, by transmitting fixed geo coordinates, such as space coordinates specified in the fixed geodetic reference system WGS 84.

A disadvantage here is that all space points relevant for the control of a machine must be converted into the coordinates of such a geodetic reference system before a machine control based on this is even possible. In many cases, this is very time-consuming and restricts the usability for spontaneous or intuitive applications where spatial coordinates cannot be determined in an exactly predictable way.

For this reason, relative reference systems are usually used in such applications. For example, a very simple implementation variant of this approach is embodied in conventional remote controls, which are generally based on the fact that the degree of deflection of a control lever or joystick from a neutral basic position is sensory detected and translated or converted into corresponding relative control variables. These relative control variables are translated back into motion commands in the controlled machine. The synchronization between the degree of deflection of the control lever and the movement of the controlled machine is the responsibility of the control operator. In this way, for example, the direction and/or speed of movement of a computer-animated object is influenced or controlled in a computer game controlled by a joystick.

However, the disadvantage here is that the controlling instance (here in the form of a remote control) requires sensors or devices for recording the degree of deflection of the control lever as well as devices for transmitting the resulting control variables to the machine to be controlled. This results in relatively complex and bulky hardware, which is specifically adapted to the respective application purpose and the device to be controlled.

### SUMMARY OF THE INVENTION

The system described herein therefore includes providing a method for controlling a machine by means of at least one spatial coordinate as a control variable as well as a control system for a machine which overcomes these disadvantages of the state of the art. The control of machines by means of space coordinates should be simplified and in particular made possible in an intuitive way. In particular, the possibility may be created to control machines without having to rely on bulky control devices, remote controls or the like.

A machine in this sense may be defined as any type of device capable of performing functions dependent on control by means of spatial coordinates. This is by no means limited to physically tangible devices or devices, but includes computer-based or software-controlled applications whose functionality is based on a controllability by spatial coordinates and which may be loaded or executable on a computer or computer connected to an image processing system. In this context, spatial coordinates are defined as any kind of data used to designate an absolute or relative spatial position.

In accordance with an embodiment of the system described herein, controlling a machine by means of at least one spatial coordinate as a control variable includes determining a vectorial space coordinate by means of a two-dimensional code applied to a carrier plane and readable by means of an optical image processing system, and transmitting the vectorial space coordinate as a control variable to a control system of the machine. This embodiment may include the following:
in a first method step, the spatial position of a normal vector perpendicular to the area center of gravity of the code is determined by means of the image processing system, and
in a second method step, the angle of rotation of a rotational movement of the carrier plane of the code about an axis of rotation perpendicular to the carrier plane is detected by means of the image processing system, the length of the normal vector being determined by means of the angle of rotation.

In this way, a machine may be controlled by means of a simple, essentially two-dimensional carrier medium on which a machine-readable, two-dimensional code may be applied and by means of which information on spatial coordinates may be generated by means of a simple hand gesture which causes the carrier medium or the code applied thereto to rotate. This information then may be used to control the machine. These spatial coordinates may be the target point or the tip of a vector whose spatial position may be determined by the normal vector determined in the first procedural step in the centroid of the area occupied by the code and whose length may be determined by the absolute amount of the angle of rotation recorded in the second procedural step in accordance with the system described herein. The angle of rotation may be defined as the deviation from an initial position detected during the application of the method in accordance with the findings.

The carrier medium may, for example, be designed as a flat card made of plastic or paper or cardboard in a first version, whereby these dimensions may be determined exclusively by the size ratios necessary for the optical resolution and recognition of the code by the image processing system. In a second version, the carrier medium may be designed as a display, for example of a conventional smartphone or tablet computer. In view of the optical resolution capacity of cameras currently available in the state of the art, the carrier medium may therefore be very small, so that it may be easily carried along and applied at any time by a human user of the method according to the system described herein.

By translatory shifting of the carrier medium within the plane spanned by the carrier medium or by the code applied to it, the position of the centroid of the surface of the code and thus the starting point of the normal vector may be shifted in the course of the first process step. The length of the vector and thus also its target point then may be determined in the course of the second process step by subsequent rotation about an axis of rotation perpendicular to the plane of the carrier. The method according to the system described herein thus may enable: the determination of a spatial coordinate; and—as soon as the captured spatial coordinate is fixed or frozen by means of a separate process step not described in detail here—control of a machine based on the spatial coordinate by means of a simple and intuitive gesture that may be easily performed by anyone with only one hand. In this context, a gesture means any kind of hand movement by means of which the carrier medium as such may be moved relative to its surroundings. In addition, such a procedure may make it particularly easy to network physical and virtual objects in the Internet of Things (IoT).

In the course of the first process step, the normal unit vector perpendicular to the area center of gravity of the code may be determined, and in the second process step a scalar for the length of the vector may be determined by means of the recorded angle of rotation, from which the spatial coordinate may be obtained as the target point by vectorial addition of the starting point or area center of gravity of the code and the scaled normal vector.

The procedure according to the system described herein may also provide that the angle of rotation or the rotational movement of the carrier plane is only recorded in the course of the second procedure step when a lower limit value is exceeded. In this way, the user-friendliness and usability of the process described herein may be improved, since the process may not be carried out even with the smallest gestures that are unintentional by the user.

Furthermore, in the course of the second process step, a scalability of the proportional length change of the vector as a function of the determined absolute rotational deflection of the carrier plane may be provided. In this way, an intuitive coarse and fine control of the target point of the vector (or the spatial coordinate), which also may be easily grasped and implemented by the user, may be re-established.

The control processes carried out by means of the method in accordance with the system described herein may not only comprise the physical navigation of the controlled machine to a space point in a real space determined by the space coordinate, but also, for example, in a virtual space the determination of a system state at a space point defined by the space coordinate. Thus, for example, the following functions of a machine controlled according to the system described herein may be realized:
The machine may be designed as a vehicle (aircraft, etc.) and may be moved to a spatial coordinate by the control method according to the system described herein.
The machine may be set up to forward the space coordinate determined according to the system described herein to another technical system (e.g., a repair database).
The machine may be set up to identify objects (e.g., components of a more complex structure) in a virtual space by means of the space coordinates determined according to the system described herein.

In accordance with an embodiment of the system described herein, the direction of rotation of the rotational movement of the carrier plane of the code may be additionally recorded by means of the image processing system in the second process step, and the direction of orientation of the normal vector may be determined with respect to the carrier plane. In this way, the scalar of the normal vector may be inverted by means of the same gesture movement and spatial points may be addressed by differently oriented rotational movements, which may be located in half-spaces separated by a virtual plane (represented by the carrier plane of the code). In this context, it should only be noted that the code should not be in the form of a rotationally symmetrical optical pattern.

An alternative design of the system described herein provides that, in a third process step, a rotation of the carrier plane of the code about an axis of rotation parallel to the carrier plane may be recorded by means of the image processing system and used as an input signal for an inversion of the orientation direction of the normal vector with respect to the carrier plane. In this way, the scalar of the normal vector may be inverted by means of a second gesture movement which may be clearly distinguishable from the first gesture movement (=rotation of the carrier plane about an axis of rotation perpendicular to the carrier plane) provided in the second process step, as soon as the deflection of the carrier plane from its initial position achieved by means of this second gesture movement exceeds a lower threshold value.

Such second gesture movement could, e.g., be predefined as a complete turning of the plane of the carrier medium (“carrier plane”) around an axis parallel to the carrier plane, so a camera of an image processing system may be directed onto a backside (i.e., reverse side) of the carrier medium after second gesture movement. A further code may be applied to this reverse side, the structure of which may correspond to that on the front side of the carrier medium, so that the procedure according to the system described herein may be continued by returning to the second procedural step and passing through it again. Alternatively, a second gesture movement also may be done by fast, short-time tilting of the carrier plane around such axis of rotation parallel to the carrier plane (and following return to starting position), so that a second code on the reverse side of the carrier medium is dispensable.

Another alternative design of the system described herein provides that the orientation direction of the normal vector with respect to the carrier level may be determined in a third procedural step by reading and decoding the code. The direction information of the normal vector thus may be part of the content coded in the code. In the course of the practical application of the method in accordance with the system described herein, it may be possible, in accordance with a sensible design variant, for the carrier medium to have different codes on both sides in this respect, so that a change or reversal of the directional information is made possible by turning the carrier medium and then reading out the code on the carrier plane which is then oriented upwards, i.e., in the direction of a camera of the image processing system.

According to an embodiment of the system described herein, the first process step comprises the following steps:
Reception of image data from at least one camera of the optical image processing system,
Evaluation of the image data for the presence of color marks,
Grouping of recognized color marks into color mark groups,
Determination of the two-dimensional coordinates of all color marks belonging to a color mark group in a coordinate system assigned to the camera,
Transformation of the two-dimensional coordinates of all color marks of a color mark group into a three-dimensional coordinate system assigned to the machine, and
Determination of the normal vector by the center of gravity of the area spanned by the color marks of a color mark group.

Numerous opto-electronically processable codes known from the state of the art have orientation marks constructed according to standardized specifications which serve for the correct two-dimensional alignment of a camera image captured by such codes. These standards also define, among other things, the proportions of these orientation marks in terms of size, orientation and relative distance from each other. The system described herein may include providing such machine-readable codes with color marks, which may be arranged at defined positions in the code and have defined proportions in relation to the code and defined colors. For each code, a number of color marks in different defined colors may be provided. A 3-tuple of different colors may be particularly advantageous. The individual color marks of a code may be integrated into orientation marks or otherwise be in a defined geometric relationship to orientation marks. Alternatively, it is also possible to position the color marks within the code independently of any orientation marks.

In accordance with an embodiment of the system described herein, the image data received from the camera of the image processing system may be continuously evaluated for the presence of color marks in the course of the first process step. Recognized color marks may be grouped into color mark groups based on the determined color and code-specific defined proportions, with each color mark group corresponding to an n-tuple of predefined colors. According to embodiments of the system described herein, the color marks of each code may be marked with a different key color. In this way, an effective preselection of the received camera image data is possible and additional information about the logical and geometrical affiliation of sensorically recognized color marks to individual codes may be generated. A color mark may be a punctiform expansion of the same hue that may extend over several pixels and may be distinguished from other pixels. In such embodiments, it may be imposed that color marks recognized as being of the same color belong to different codes, while color marks recognized as being of different colors may be components of the same code, provided that their distances from each other do not exceed a defined amount depending on their proportions.

In a next sub-step, the two-dimensional coordinates of all color marks belonging to a common color mark group may be determined, whereby a first coordinate system related to the camera may serve as the reference system, and in a further sub-step may be transformed into a second absolute coordinate system, which is superordinate to the first coordinate system related to the camera. For this purpose, the three-dimensional geometry of the plane spanned by the color mark group may be reconstructed by a central projection known per se from the known positions, and dimensions and orientations of the color marks in the undistorted code and their plane equations may be determined. From the cross product of two vectors spanning this plane, the normal vector may be determined in a last sub-step and finally, together with the centroid of area, the surface normal of this plane may be determined. In this way, embodiments of the method make it possible to determine the three-dimensional coordinates and the normal of this plane. In an advantageously standardized code, the various color marks of the code may be positioned in such a way that the area normal (i.e., a vector normal to the area) of the plane spanned by a group of color marks corresponds to the area normal of the carrier plane of the code.

It may be particularly advantageous in this context if at least one bit mask is created for evaluating the image data, which may be matched to the key colors contained in the color marks. The use of key colors may be used to optically cut out the color marks from the background and the rest of the code. The camera and the release method should therefore be calibrated by a series of measurements; for example, a white balance should be carried out on the camera and the threshold values for a release should be set to the color tones measured in the test image, including a tolerance of approx. plus/minus 2-3%. Depending on the environment, a white balance to the light color should also be carried out during operation, e.g., to correct the time-dependent sun color or ceiling lighting, since the color captured by the camera is produced by subtractive color mixing of the color marks with the lighting. In addition, the exemption procedure should also exempt image parts with a low color saturation or brightness (below 15-25%) in order to reduce measurement errors. The setting of the tolerance and threshold values should not be too low, since the colors may not be necessarily measured directly. However, at low resolution through additive color mixing of the image within the individual pixels captured by the camera, mixed tones may arise from the white and black image elements in the immediate vicinity of the color mark in the code. On the other hand, the setting of the tolerance and threshold values should not be too high in order to be able to identify the picture elements with the necessary sharpness.

It may be advantageous in this context if one or each color mark is designed to emit light, for example, as a light source, which may eliminate the abovementioned problems with subtractive color mixing. In addition, additive color mixing may be influenced in intensive light sources in favor of color recognition, since the weighting plays a role. In addition, the use of embodiments of the method according to the system described herein may be improved under poor visibility conditions, e.g., at night.

One possible form of the system described herein is that the code is executed as a two-dimensional QR code. Such QR codes are widely used and may be used in existing systems because of their standardized properties. In particular, the color marks may be integrated into the orientation marks of the QR code. A QR code whose color marks each form a 3×3 element inner part of an orientation mark of the QR code, each color mark being colored in a key color which is distinguishable from the other color marks of the same QR code, with full color saturation, may be particularly suitable for the application of embodiments of the method according to the system described herein. In addition, the arrangement of the differently colored color marks may be identical within each QR code. In some embodiments, the other elements of the QR code outside the color mark ideally consist only of elements colored black or white. The dimensions of the QR code may be as small as possible, for example, limited to 21×21 elements. In this way, the dimensions of the orientation marks in relation to the code may be maximum.

An area around the QR code may be configured to remain free of colors (except gray tones) to improve the determination of color groups or area normals in cases of optical overlay or when key colors are used outside the QR code. It has proved to be useful if the width of this open space corresponds to at least seven elements.

Two alternatives for encoding additional information in such a QR code in accordance with embodiments of the system described herein will now be described.

According to a first design variant, a QR code is divided horizontally and vertically into segments of as equal a size as possible, whereby the color marks are arranged in one of these segments. Additional information may be coded in the other segments that do not have color marks by means of additional key colors that differ from the key colors of the color marks.

Alternatively, it is conceivable to attach an additional code at an exactly defined position next to or in the spatial environment outside the QR code, whereby its elements are dimensioned in such a way that this additional code may be read from a great distance.

In both alternatives described above, the image should be transformed before the additional color code is evaluated using the plane equations determined by embodiments of the system described herein, so that a line-oriented scan of the color pattern is possible. For this purpose, the position of each segment may be determined by interpolating the coordinates of the recognized color marks, and the coloration of each segment may be determined and checked for correspondence with a key color. Since the measuring range of each segment may extend over several pixels or elements, the coloration of the segment may be determined by calculating the mean value.

A design variant of the system described herein provides that the code is implemented as a two-dimensional arrangement of at least two color marks, each color mark being arranged to display at least two individual color states for the respective color mark, and one of these color marks being additionally arranged to change with the carrier frequency between a first and a second color state. A color mark is a punctiform extension of the same hue that may extend over several pixels and is distinguishable from other pixels. A first color mark may serve as a carrier signal that changes continuously between two color states. The at least one further color mark of the same arrangement of color marks is used for the transmission of the data values (i.e., the user data to be transmitted). As soon as a change of state for the color mark assigned to the carrier signal is detected on the receiver side, a change of state in the form of a color state deviating from the previous state kᵢ should also be detected for at least one further color mark. Otherwise a faulty image may be present. On the receiver side, all images may be discarded if at least two consecutive images do not represent the same state. Otherwise, the receiving device may detect the presence of a faulty intermediate image and reject it. A colorless change in brightness between black and gray is may be desirable for the color mark of the carrier signal. The use of saturated colors (color angles) may be desirable for the color marks of the data values.

According to embodiments of the system described herein, the color shades should be chosen in such a way that the color states of the color marks are represented with approximately the same brightness in order to avoid glare effects in the receiving device.

It is may be particularly advantageous that the data to be transmitted is coded as a two-dimensional arrangement of at least three color marks. In this way it is possible to detect the spatial position of the color marks in relation to each other and thus also the three-dimensional spatial position of the display device or the carrier level of the authentication code to be transmitted by means of an appropriately equipped receiving device. In particular, a control unit assigned to the receiving device may be used to determine the surface normal of the carrier plane. This may be particularly advantageous for applications where the receiving device is assigned to a remote-controlled vehicle or aircraft (such as a drone). By determining the surface normal of the carrier plane of the authentication code, drive control variables may be determined which, for example, bring the vehicle or aircraft into a position in which the optical axis of the receiving device corresponds to the surface normal of the carrier plane, or the distance is adapted by evaluating the angle of rotation. A potential advantage in connection with the system described herein is that inputs from a user who performs control gestures with a display device in accordance with the system described herein, which change the spatial position of the color marks in relation to the receiver, may be secured by means of authentication.

First, the image data received by the receiving device may be continuously evaluated for the presence of color marks. Recognized color marks may be grouped into color mark groups based on the determined color and the application-specific defined proportions, whereby each color mark group corresponds to an n-tuple of predefined colors. According to the system described herein, the color marks of each code may be marked with a different key color. In this way, an effective preselection of the received camera image data is possible and additional information about the logical and geometrical affiliation of sensorically recognized color marks to individual codes may be generated. For example, it may be imposed that color marks recognized as being of the same color belong to different codes, while color marks recognized as being of different colors may be components of the same code, provided that their distances from each other do not exceed a defined amount depending on their proportions.

In a next sub-step, the two-dimensional coordinates of all the color marks belonging to a common color mark group may be determined, a coordination system assigned to the receiving device serving as the reference system. In a further sub-step, the two-dimensional coordinates may be transformed into a three-dimensional coordination system assigned to the vehicle or the receiving device. For this purpose, the three-dimensional geometry of the plane spanned by the color mark group may be reconstructed by a known centered projection from the known positions, dimensions and orientations of the color marks in the undistorted code, and plane equations for the three-dimensional geometry may be determined. From the cross product of two vectors spanning this plane, the normal vector may be determined in a last sub-step and finally, together with the centroid of area, the surface normal of this plane may be determined. In this way, embodiments of the method make it possible to determine the three-dimensional coordinates and the normal of this plane. In a standardized code, the various color marks of the code may be positioned in such a way that the area normal of the plane spanned by a group of color marks corresponds to the area normal of the carrier plane of the code. Then the control variables for controlling the machine may be output to the machine in such a way that this or the receiving device mounted on this vehicle may be guided into a position which lies within a conical spatial region, the axis of the cone being defined by the surface normal of the carrier plane. The angle of aperture and the height of the cone may be determined by the optical parameters of the receiving device, i.e., they correspond to the values within which the resolving power of the receiving device is sufficient to detect the code in terms of angular deviation and distance.

Such embodiments of a method according to the system described herein may be effectively supported by the fact that the spatial arrangement of the color mark assigned to the carrier signal may be fixed and unchangeable in relation to the at least one other color mark. Such a fixed relationship may facilitate the evaluation of the color marks. Since the spatial relationship between the color marks is known, and therefore color marks do not have to be searched for first, the color tone black also may be used as a color state in this way.

It may be advantageous to use embodiments of system described herein within an augmented reality model to visualize objects identifiable by means of the spatial coordinate in a virtual space. For example, a machine according to the system described herein may be designed as an augmented reality system whose components may be addressed or activated as a function of the spatial coordinate generated by embodiments of the method in accordance with the system described herein, and as a result of this activation may be displayed on a monitor. In this way, a visualization system may be realized in which components that are not visible in reality (e.g., because they are hidden by other components) may be virtually controlled by means of a vector arrow and activated for visualization. With the help of the vector length control according to the system described herein (according to the second process step), different planes of sight lying one above the other (or arranged one behind the other) may be (de)activated or regulated. For example, the spatial coordinates or the vector may be faded into the real world with an operator using a three-dimensional augmented reality system (known designs for this include so-called “data glasses,” but also applications for mobile devices such as smartphones or tablet PCs). In this way, a kind of virtual X-ray view may be realized, i.e., objects that are not immediately visible in reality (e.g., hidden by another object in front of it in the direction of vision) may be displayed in the Augmented Reality System and controlled according to embodiments of the system described herein. By means of a control method according to embodiments of the system described herein, the different viewing planes may be controlled or regulated by influencing the vector length

Embodiments of the system described herein further may comprise a device-oriented control system of a machine, where the control system is arranged by means of an optical image processing system for: determining the spatial position of a normal vector perpendicular to the center of gravity of a surface of a two-dimensional code applied to a carrier plane and readable by means of the optical image processing system; detecting the angle of rotation of a rotational movement of the carrier plane of the code about an axis of rotation perpendicular to the carrier plane; and determining the length of the normal vector by means of the angle of rotation. In some embodiments, the control system is also set up to determine the direction of the normal vector.

### BRIEF DESCRIPTION OF THE DRAWINGS

The system described herein will be explained in more detail below using an example and drawings. Shown below:

FIG. 1 is a schematic representation of a control procedure according to an embodiment of the system described herein;

FIG. 2 is an alternative structure for carrying out the control procedure according to an embodiment of the system described herein;

FIG. 3 is a schematic structure of a smartphone display set up as a display device for a dynamic code according to an embodiment of the system described herein; and

FIG. 4 is a schematic representation of a coded signal sequence k1 to k8 according to an embodiment of the system described herein.

### DETAILED DESCRIPTION OF VARIOUS EMBODIMENTS

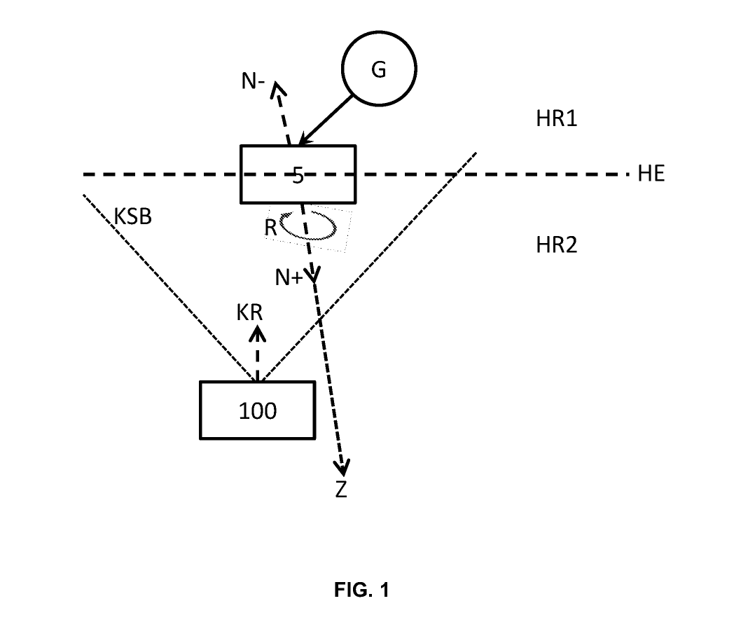

FIG. 1 shows a schematic representation of a method of control according to an embodiment of the system described herein. A gesture generator (G) has a sample card (5) which has a machine-readable two-dimensional code printed on one side. Alternatively, also may be the sample card has machine-readable two-dimensional code printed on both sides, whereby the contents of both codes differ from each other in at least one information element. The pattern card (5) (or, more specifically, the surface of the pattern card bearing the code) defines a carrier plane (HE). As an alternative to a sample card, a display of a smartphone or tablet PC also may be provided.

In this embodiment, the machine has an optical image processing system with a camera (100). This camera (100) has a field of view (KSB) which is essentially determined by the viewing direction or optical axis (KR) of the camera, as is known in the art. In a neutral basic position, the carrier plane (HE) is essentially aligned at a right angle to the camera axis (KR).

The gesture generator (G) then may use the pattern card (5) to define a virtual vector, which points to a spatial coordinate (Z) starting from the centroid of the area of the code applied to the surface of the pattern card facing the camera. In a first step, the pattern map (5) may be tilted in space so that the normal vector (N+) is oriented in the direction of the target space coordinate (Z). The spatial coordinate may be any point within the first half-space (HR1) facing the camera or within the field of view of the camera (KSB). To control points in the second half space (HR2) remote from the camera, the direction of the normal vector may be switched (N+). This changeover may be effected by a rotary movement in the opposite direction (in the case of a code applied to one side of the carrier medium) or alternatively (in the case of codes applied to two sides of the carrier medium) by turning the carrier medium over and then decoding the coded content.

In a second process step, the length of the vector may be set to the length required to reach the target spatial coordinate (Z) by means of a rotational movement (R). To improve serviceability, a rotation angle range from [+30° ] to [−30° ] may not be transferred to control information (i.e., the length of the vector is not changed for rotation movements within this angle range). For angles of rotation with an amount greater than 30°, the vector length may be continuously shortened or lengthened, whereby the rate of change increases disproportionately with increasing angle of rotation.

As soon as the target space coordinate (Z) is determined in this way, a process based on this may be started by forwarding the control variables based on this space coordinate to a further processing device of the machine to be controlled. Such control may include, e.g., movement of the machine in the direction of the target space coordinate (Z) or identification by the machine of a component related to this space coordinate.

Furthermore, the further processing device of the machine may synchronize the visualization process with data glasses, whereby both the target spatial coordinate (Z) as well as the vector and the identified component may be displayed in the field of vision of the data glasses.

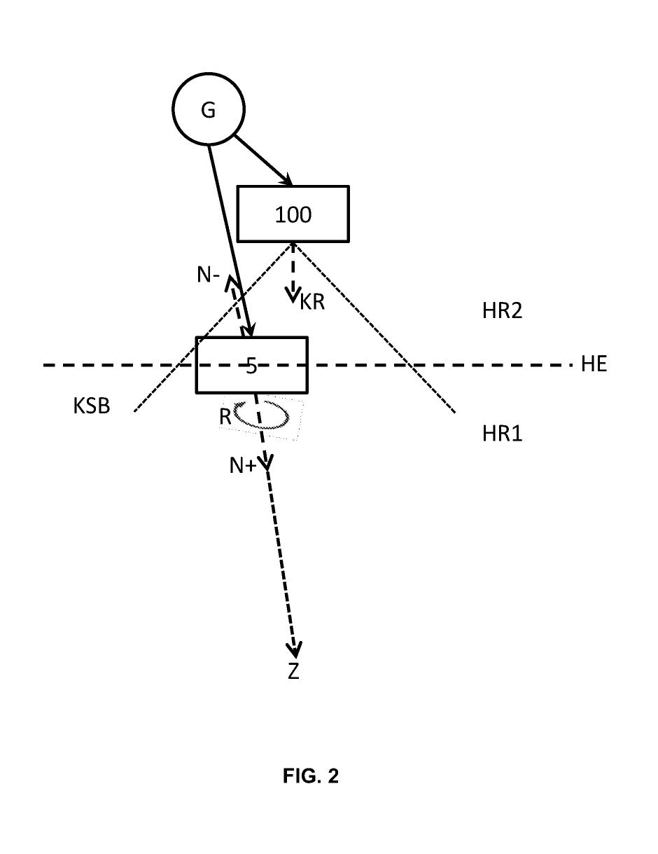

FIG. 2 shows an alternative structure for the execution of a procedure according to an embodiment of the system described herein, in which the direction of the camera (100) is oriented away from the gesture transmitter (G). This may be the case, for example, if the gesturer holds the camera (e.g., integrated in a smartphone) with a first hand and the carrier medium (5) of the code with a second hand and points the camera at the code.

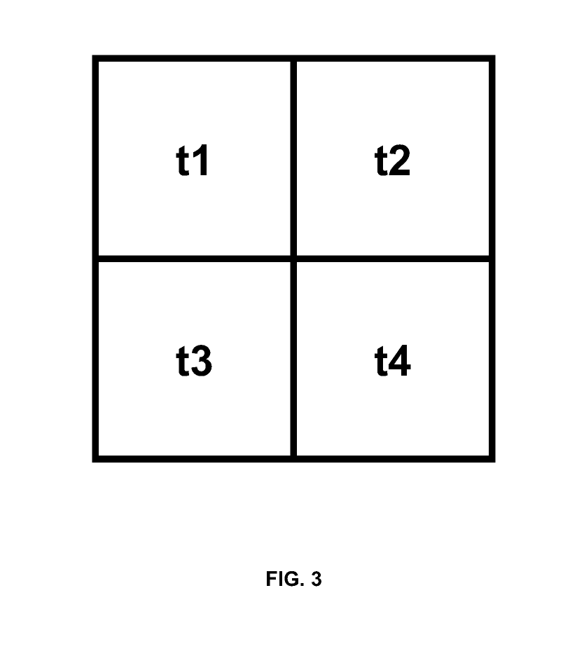

Embodiments of the system described herein are not only applicable in connection with static codes, but also in connection with dynamic two-dimensional codes. FIG. 3 shows the schematic structure of a display device, which is part of a system for authenticating a user to a central instance for releasing user-specific authorizations. In addition to the determination of the control variables according to the system described herein, an authorization check of the user also may take place at the same time. The carrier medium for the code may be formed by the display of a conventional smartphone, which—after activation of a corresponding software application stored on the smartphone—may divide the display area into approximately four rectangular segments of equal size, which may be arranged horizontally and vertically in pairs. Each of these segments may form a color mark (t1, t2, t3, t4). Each of these color marks (t1, t2, t3, t4) may be set to display two individual color states for each color mark. A first color mark (t1) may be set up to alternately display the gray and black color states; the remaining color marks may be as follows:

second color mark (t2) between green and yellow;

third color mark (t3) between orange and red; and

fourth color mark (t4) between purple and turquoise.

For the color marks (t2, t3, t4) of the data values, saturated colors (e.g., color angles) may be used. The color tones may be selected so that the color states of the color marks may be displayed with approximately the same brightness in order to avoid glare effects in the receiving device.

Thus, all color marks (t1, t2, t3, t4) of this two-dimensional arrangement may show at any time, i.e., independent of their current display state, a color state that may be clearly assigned to the respective color mark. The last three color marks (t2, t3, t4) may be designed in a manner known from the state of the art to display optically coded information by means of color changes. In an embodiment of the system described herein, the additional first color mark (t1), has color states that change at a predeterminable frequency (sometimes referred to herein as carrier frequency), this carrier frequency corresponding to the color change frequency of the other color marks (t2, t3, t4). By means of a conventional camera (not shown in this example for reasons of clarity), the central release instance may receive the image emitted in this way from the display and—in addition to determining the control variables—evaluates the image with regard to the authentication information encoded in it by color changes.

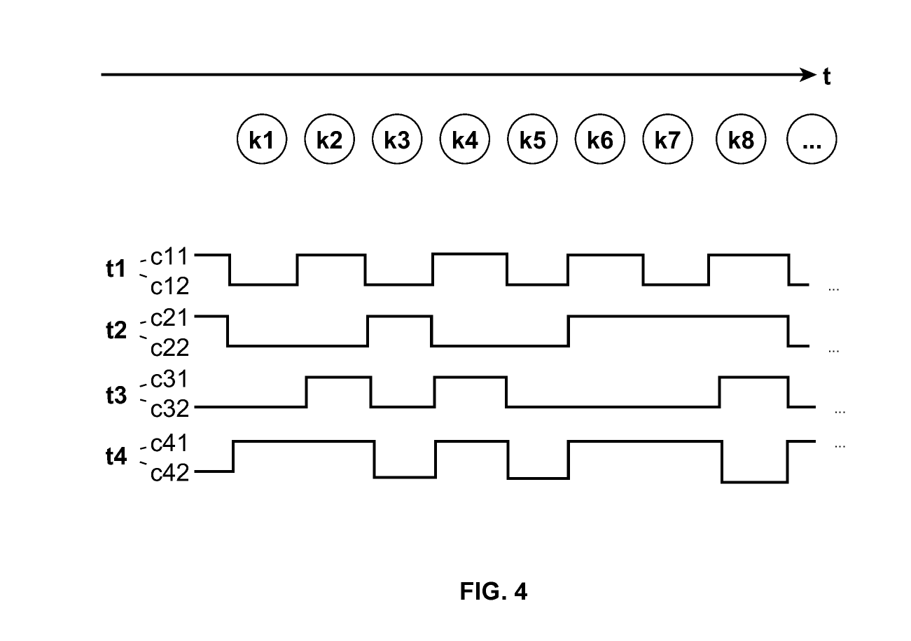

FIG. 4 shows color states (c11, . . . c42) displayed on the color marks (t1, t2, t3, t4) of the states k1, k2 . . . k8 over time, in accordance with an embodiment of the system described herein. Each color mark tᵢ may alternate between its two characteristic color states cᵢ1 and cᵢ2 according to a pattern determined by the content of the coded identification data, with the exception of the color mark t1, which may alternate between its two color states c11 and c12 with a fixed carrier frequency. However, the color change of each color mark between a first state kᵢ and a second state kᵢ₊₁ following this in time may not take place in absolute synchronicity with the respective state changes of the other color marks shown on the display. This may be caused by the use of complex software and hardware components, such as a graphics library or the display technology of the display. This means that an image representation may be built up exactly during the change of state from the first state kᵢ to the second state kᵢ₊₁ and then in the result may partly represent the old state kᵢ, but partly also the new state kᵢ₊₁. This is also favored by the fact that the respective changes between the two color states cᵢ1 and cᵢ2 may not occur in an absolutely seamless manner, i.e., not immediately or abruptly, but require a certain period of time. The switching flanks between the two color states therefore may not be vertical in reality, but the switching processes may be rather oblique and steady—when viewed with sufficient precision.

As soon as a status change for the color mark (t1) assigned to the carrier signal is detected on the receiver side, a status change in the form of a color state deviating from the previous state kᵢ should also be detected for each of the other color marks (t2, t3, t4). Otherwise, a faulty picture may be present. On the receiver side, all images may be discarded if at least two consecutive images do not represent the same state. Otherwise, the receiving device may detect the presence of an erroneous intermediate image and reject it.

Various embodiments of the system described herein may be implemented using software, firmware, hardware, a combination of software, firmware and hardware and/or other computer-implemented modules, components or devices having the described features and performing the described functions. Software implementations of embodiments of the invention may include executable code that is stored one or more computer-readable media and executed by one or more processors. Each of the computer-readable media may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer-readable medium or computer memory on which executable code may be stored and executed by a processor. Embodiments of the invention may be used in connection with any appropriate operating system.

Other embodiments of the invention will be apparent to those skilled in the art from a consideration of the specification and/or an attempt to put into practice the invention disclosed herein. It is intended that the specification and examples be considered as exemplary only, with the true scope and spirit of the invention being indicated by the following claims.

What is claimed is:

1. A method of controlling a machine, comprising:
visually detecting a two-dimensional code on a plane of a carrier medium;
determining a spatial position of a normal vector perpendicular to the centroid of the area of the two-dimensional code;
detecting an angle of rotation of a rotational movement of the plane about an axis of rotation perpendicular to the plane;
determining a length of the normal vector based on the angle of rotation;
determining a vectorial spatial coordinate from the spatial position of the normal vector and the length of the normal vector; and
transmitting the vectorial spatial coordinate as a control variable to a control system of the machine.

2. The method according to claim 1, further comprising:
detecting a direction of rotation of the rotational movement of the plane; and
determining a direction of orientation of the normal vector with respect to the plane from the detected direction.

3. The method according to claim 1, further comprising:
detecting a rotation of the plane about an axis of rotation parallel to the plane; and
inverting an orientation direction of the normal vector with respect to the carrier plane using the detected rotation.

4. The method according to claim 1, further comprising:
determining a direction of orientation of the normal vector with respect to the plane by reading out and decoding the code.

5. The method according to claim 1, further comprising:
receiving image data from at least one camera of an optical image processing system;
evaluating the image data for the presence of color marks;
grouping recognized color marks into color mark groups;
determining two-dimensional coordinates of the color marks belonging to at least one of the color mark groups in a coordinate system assigned to the camera;
transforming the two-dimensional coordinates of the color marks of the at least one color mark group into a three-dimensional coordinate system assigned to the machine; and
determining the normal vector based at least in part on the center of gravity of the area spanned by the color marks of the at least one color mark group.

6. The method according to claim 5, further comprising:
producing at least one bit mask for evaluating the image data, which bit mask is matched to key colors included in the color marks.

7. The method according to claim 5, wherein each color mark is light-emitting.

8. The method according to claim 1, wherein the code is designed as a two-dimensional arrangement of at least two color marks), each color mark being set up to display at least two individual color states for the respective color mark, and one of the color marks additionally being set up to change at a carrier frequency between a first and a second color state.

9. The method according to claim 1, wherein the method is used within an augmented reality model for visualizing objects that can be identified in a virtual space using the vectorial spatial coordinate.

10. A system for controlling a machine, comprising:
an image processing device that reads a two-dimensional code on a plane of a carrier medium, determines a spatial position of a normal vector perpendicular to the centroid of the area of the two-dimensional code, and detects an angle of rotation of a rotational movement of the plane about an axis of rotation perpendicular to the plane; and
one or more control components that determine a length of the normal vector based on the angle of rotation, determine a vectorial spatial coordinate from the spatial position of the normal vector and the length of the normal vector, and control transmitting the vectorial spatial coordinate as a control variable to a control system of the machine.

11. The system according to claim 10, wherein the image processing device detects a direction of rotation of the rotational movement of the plane; and
wherein a direction of orientation of the normal vector with respect to the plane is determined from the detected direction.

12. The method according to claim 10, wherein the image processing device detects a rotation of the plane about an axis of rotation parallel to the plane, and
wherein an inversion of an orientation direction of the normal vector with respect to the carrier plane uses the detected rotation.

13. The system according to claim 10, wherein the image processing device reads out the code, and
wherein a direction of orientation of the normal vector with respect to the plane is determined by decoding the code.

14. The system according to claim 10, wherein the image processing device receives image data from at least one camera of an optical image processing system, and
wherein the one or more control components evaluate the image data for the presence of color marks, group recognized color marks into color mark groups, determine two-dimensional coordinates of the color marks belonging to at least one of the color mark groups in a coordinate system assigned to the camera, transform the two-dimensional coordinates of the color marks of the at least one color mark group into a three-dimensional coordinate system assigned to the machine, and determine the normal vector based at least in part on the center of gravity of the area spanned by the color marks of the at least one color mark group.

15. The system according to claim 14, wherein the one or more control components produce at least one bit mask for evaluating the image data, which bit mask is matched to key colors included in the color marks.

16. The system according to claim 14, wherein each color mark is light-emitting.

17. The system according to claim 10, wherein the code is designed as a two-dimensional arrangement of at least two color marks), each color mark being set up to display at least two individual color states for the respective color mark, and one of the color marks additionally being set up to change at a carrier frequency between a first and a second color state.

18. The system according to claim 10, further comprising:
an augmented reality model for visualizing objects that can be identified in a virtual space using the vectorial spatial coordinate.

19. A method of controlling a machine, comprising:
visually detecting a two-dimensional code on a plane of a carrier medium;
determining a vectorial spatial coordinate from the detected two-dimensional code;
transmitting the vectorial spatial coordinate as a control variable to a control system of the machine.

20. The method of claim 19, wherein determining a vectorial spatial coordinate from the detected two-dimensional code includes:
determining a spatial position of a normal vector perpendicular to the centroid of the area of the two-dimensional code;
detecting an angle of rotation of a rotational movement of the plane about an axis of rotation perpendicular to the plane;
determining a length of the normal vector based on the angle of rotation; and
determining the vectorial spatial coordinate from the spatial position of the normal vector and the length of the normal vector.
